(19) United States
(12) Patent Application Publication
(10) Pub. No.: US 2023/0069171 A1
(43) Pub. Date: Mar. 2, 2023

(54) OPERATOR ASSISTANCE SYSTEM FOR WORK MACHINE

(71) Applicant: Caterpillar Inc., Peoria, IL (US)

(72) Inventors: Rodrigo Sanchez, Vail, AZ (US); Camilo Galofre, Oro Valley, AZ (US); Eric James Ruth, Peoria, IL (US)

(73) Assignee: Caterpillar Inc., Peoria, IL (US)

(21) Appl. No.: 17/411,445

(22) Filed: Aug. 25, 2021

(51) Int. Cl. B60L 5/36; B60L 5/24; B60R 11/04; B60L 3/00

(52) U.S. Cl. CPC B60L 5/36; B60L 5/24; B60R 11/04; B60L 3/00; B60L 2200/44

(57) ABSTRACT

An operator assistance system associated with a work machine includes an imaging device mounted on the work machine and facing an overhead line and a pantograph of the work machine. The imaging device captures an input image including a first pictorial view that includes the overhead line. The operator assistance system also includes a controller communicably coupled with the imaging device. The controller generates an output image including a second pictorial view and a first indication element overlayed on the second pictorial view. The first indication element defines a reference zone, such that a presence of the overhead line of the second pictorial view within the reference zone indicates that the work machine is in desired alignment with the overhead line. The operator assistance system further includes a display device to display the output image thereon for providing a visual indication to an operator.

### TECHNICAL FIELD

The present disclosure relates to an operator assistance system associated with a work machine, and a method of assisting an operator of the work machine.

### BACKGROUND

Work machines, such as mining machines, off-highway trucks, on-highway trucks, dump trucks, articulated trucks, and the like, may include a pantograph that contacts with one or more overhead lines for receiving electric power. For example, the overhead lines may be used to provide operating power to the work machine for movement on a grade, thereby allowing the work machine to idle and/or avoid using an onboard internal combustion engine, and so save fuel. In some examples, the work machine may embody an electric machine that requires electric power for operational purposes. Typically, an operator of the work machine may align the pantograph with the overhead lines to establish a contact between the pantograph and the overhead lines.

However, an operator seated within an operator cabin may not have visual access to the overhead lines and the pantograph, either when the work machine is in motion or is stationary. Thus, in some situations, it may be possible that the operator may raise the pantograph when the pantograph is not in alignment with the overhead lines. In such situations, when the operator lowers the pantograph to realign the pantograph with the overhead lines, the overhead lines may be unintentionally pulled down by the pantograph. Such a phenomenon may cause arcing issues and may also damage the overhead lines or an infrastructure of the overhead lines, which is not desirable. Similar problems may arise if, while the work machine is in motion, the operator does not maintain proper contact between the pantograph and the overhead lines. Moreover, such situations may also impact a performance of the work machine, may lead to a breakdown of the work machine, may increase machine downtime, or may cause other consequences including personnel injury.

Therefore, it may be desirable to have a system and a method that allows the operator to monitor the contact between the overhead lines and the pantograph of the work machine, especially while the work machine is in motion.

U.S. Patent Application Publication Number 2020/0285861 describes a monitor device for trolley type vehicle. The monitor device is provided with an imaging device that shoots an overhead line and a current collector, and a controller that processes an image. The controller includes a day or night determination processing section, and an image processing section that switches a parameter for recognizing the overhead line and the current collector in the image by executing image processing different in the daylight and at night based upon the result of the day or night determination. Further, there are provided reference photographic subjects to be shot by the imaging device in positions different from the overhead line and the current collector in an image area to be shot, and the day or night determination processing section performs the determination of day or night based upon a luminance average value of the reference photographic subjects inputted into an image input section.

### SUMMARY OF THE DISCLOSURE

In one aspect of the present disclosure, an operator assistance system associated with a work machine is provided. The work machine includes a pantograph adapted to engage with at least one overhead line for supplying electric power to the work machine. The operator assistance system includes an imaging device mounted on the work machine and facing the overhead line and the pantograph. The imaging device is configured to capture an input image including a first pictorial view that includes the overhead line. The operator assistance system also includes a controller communicably coupled with the imaging device. The controller is configured to receive the input image from the imaging device. The controller is also configured to generate an output image including a second pictorial view and at least one first indication element overlayed on the second pictorial view. The second pictorial view is at least in part derived from the first pictorial view and includes the overhead line. The at least one first indication element defines at least one reference zone, such that a presence of the overhead line of the second pictorial view within the at least one reference zone indicates that the work machine is in desired alignment with the overhead line. The operator assistance system further includes a display device mounted on the work machine and configured to receive the output image from the controller. The display device is configured to display the output image thereon for providing a visual indication to an operator signifying an alignment of the work machine relative to the overhead line.

In another aspect of the present disclosure, a work machine is provided. The work machine includes a frame. The work machine also includes an operator cabin supported by the frame. The work machine further includes a pantograph adapted to engage with at least one overhead line for supplying electric power to the work machine. The work machine includes an operator assistance system for providing a visual indication to an operator regarding an alignment of the work machine relative to the overhead line. The operator assistance system includes an imaging device mounted on the work machine and facing the overhead line and the pantograph. The imaging device is configured to capture an input image including a first pictorial view that includes the overhead line. The operator assistance system also includes a controller communicably coupled with the imaging device. The controller is configured to receive the input image from the imaging device. The controller is also configured to generate an output image including a second pictorial view and at least one first indication element overlayed on the second pictorial view. The second pictorial view is at least in part derived from the first pictorial view and includes the overhead line. The at least one first indication element defines at least one reference zone, such that a presence of the overhead line of the second pictorial view within the at least one reference zone indicates that the work machine is in desired alignment with the overhead line. The operator assistance system further includes a display device mounted on the work machine and configured to receive the output image from the controller. The display device is configured to display the output image thereon for providing a visual indication to an operator signifying an alignment of the work machine relative to the overhead line.

In yet another aspect of the present disclosure, a method of assisting an operator of a work machine is provided. The work machine includes a pantograph adapted to engage with at least one overhead line for supplying electric power to the work machine. The method includes capturing, by an imaging device mounted on the work machine and facing the overhead line and the pantograph, an input image including a first pictorial view that includes the overhead line. The method also includes receiving, by a controller communicably coupled with the imaging device, the input image from the imaging device. The method further includes generating, by the controller, an output image including a second pictorial view and at least one first indication element overlayed on the second pictorial view. The second pictorial view is at least in part derived from the first pictorial view and includes the overhead line. The at least one first indication element defines at least one reference zone, such that a presence of the overhead line of the second pictorial view within the at least one reference zone indicates that the work machine is in desired alignment with the overhead line. The method includes displaying the output image on a display device mounted on the work machine for providing a visual indication to the operator signifying an alignment of the work machine relative to the overhead line. The display device is configured to receive the output image from the controller.

Other features and aspects of this disclosure will be apparent from the following description and the accompanying drawings.

### BRIEF DESCRIPTION OF THE DRAWINGS

FIG. 1 illustrates a perspective view of a work machine, according to examples of the present disclosure;

FIG. 2 illustrates a block diagram of an operator assistance system associated with the work machine of FIG. 1, according to examples of the present disclosure;

FIG. 3 illustrates a block diagram of a controller associated with the operator assistance system of FIG. 2, according to examples of the present disclosure;

FIG. 4 illustrates an input image generated by an imaging device of the operator assistance system of FIG. 2, according to examples of the present disclosure;

FIG. 5 illustrates an output image generated by the controller of FIG. 3, according to one example of the present disclosure;

FIG. 6 illustrates an output image generated by the controller of FIG. 3, according to another example of the present disclosure;

FIG. 7 illustrates an output image generated by the controller of FIG. 3, according to yet another example of the present disclosure; and

FIG. 8 illustrates a flowchart for a method of assisting an operator of the work machine, according to examples of the present disclosure.

### DETAILED DESCRIPTION

Wherever possible, the same reference numbers will be used throughout the drawings to refer to the same or like parts. Wherever possible, corresponding or similar reference numbers will be used throughout the drawings to refer to the same or corresponding parts.

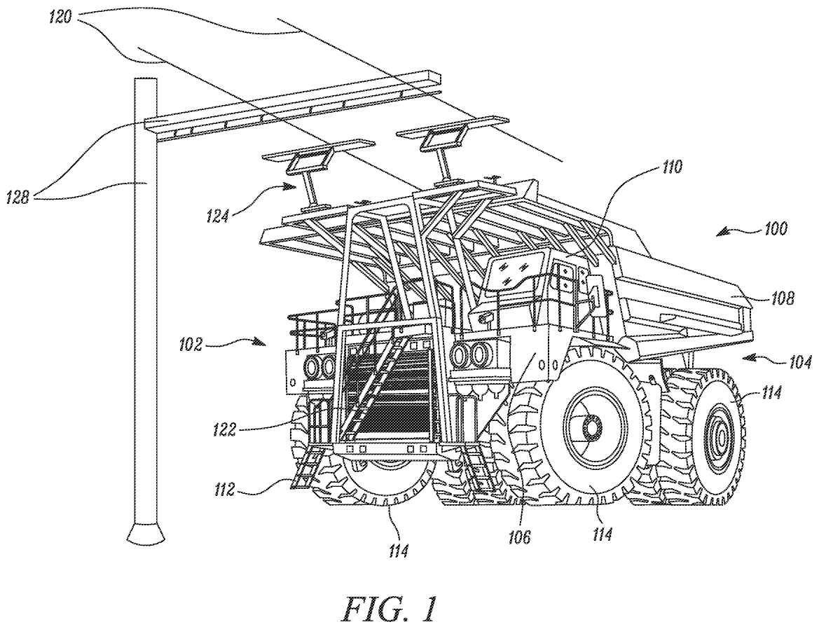

FIG. 1 illustrates an exemplary work machine 100. The work machine 100 is embodied as a mining truck herein. Although shown as the mining truck, it may be understood that the work machine 100 may alternatively include other work machines, such as, off-highway trucks, on-highway trucks, dump trucks, articulated trucks, and the like, without any limitations.

The work machine 100 may define a front end 102 and a rear end 104. The work machine 100 includes a frame 106. The work machine 100 may also include a truck bed 108. The truck bed 108 of the work machine 100 may define a volume (not shown) to receive a payload (not shown) therein. The truck bed 108 may be pivotally connected to the frame 106 and may be arranged to carry the payload for transportation purposes.

In some examples, the work machine 100 may include an electric work machine. In other examples, the work machine 100 may operate based on output power received from a power source as well as electric power from an external source (such as overhead lines 120). The power source (not shown) may include an engine, batteries, fuel cells, and the like, without any limitations. The power source may generate the output power for performing one or more work operations. The power source may be an internal combustion engine. The power source may be disposed within a compartment (not shown) defined by the frame 106. The work machine 100 also includes a radiator 122 disposed at the front end 102 of the work machine 100. The radiator 122 may be used for cooling the power source or other components of the work machine 100.

The work machine 100 also includes an operator cabin 110 supported by the frame 106. The operator cabin 110 may include a user interface (not shown). The user interface may embody an input and output device that may assist an operator in operating the work machine 100. The user interface may be embodied as a main display of the work machine 100. The work machine 100 may further include a staircase 112 supported by the frame 106 proximate the front end 102 of the work machine 100. The staircase 112 may allow the operator or servicing personnel to enter the operator cabin 110 or access a platform of the work machine 100.

The work machine 100 may also include a number of wheels 114 for movement purposes. In the illustrated example, the work machine 100 may include two wheels 114 disposed proximate the front end 102 of the work machine 100 and two pairs of wheels 114 (only one of which is illustrated in FIG. 1) disposed proximate the rear end 104 of the work machine 100. Alternatively, the work machine 100 may include tracks instead of the wheels 114. Further, the wheels 114 may be supported by axles (not shown).

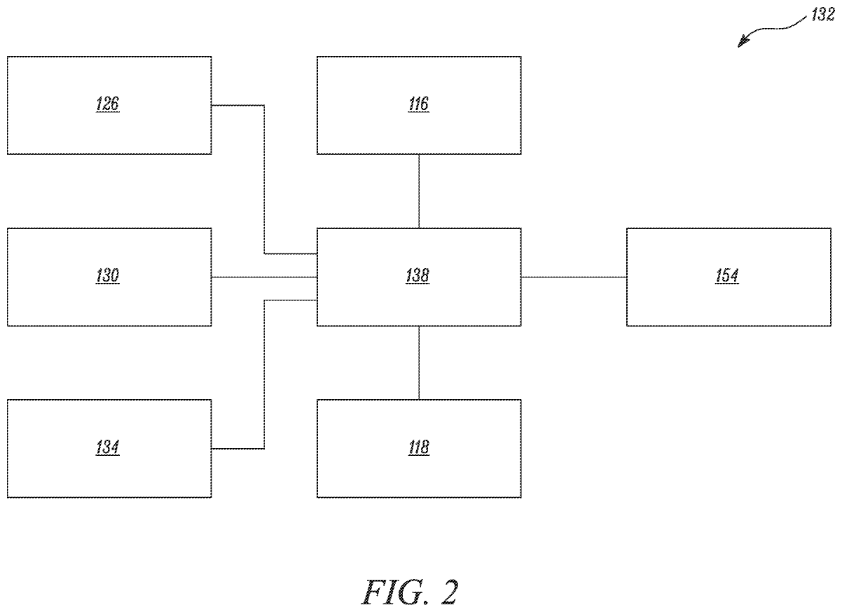

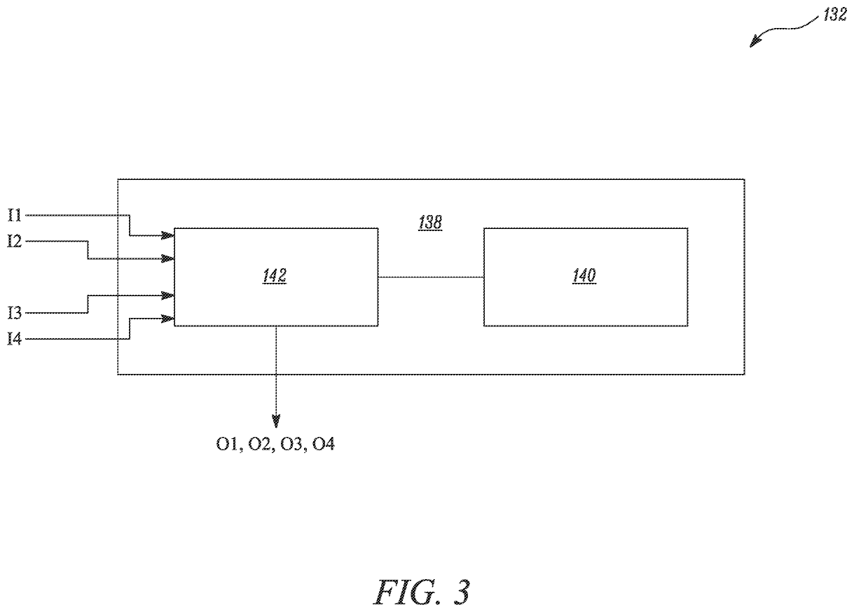

The work machine 100 may further include a speed sensor 116 (shown in FIG. 2) to determine a speed of the work machine 100. The speed sensor 116 may generate an input signal “I1” (shown in FIG. 3) corresponding to the speed of the work machine 100. In the present disclosure, the input signal “I1” may be interchangeably referred to as a signal “I1”. The speed sensor 116 may include a tachometer. In an example, the speed sensor 116 may measure a rotational speed of the axle. Alternatively, the speed sensor 116 may include a wheel speed sensor. It should be noted that the work machine 100 may include any type of speed sensor 116 that generates the input signal “I1” corresponding to the speed of the work machine 100, without any limitations.

The work machine 100 also includes a steering angle sensor 118 (shown in FIG. 2) to determine a steering angle of the work machine 100. In some examples, the steering angle sensor 118 may determine a steering angle velocity of the work machine 100. The steering angle sensor 118 may generate an input signal “I2” (shown in FIG. 3) corresponding to the steering angle of the work machine 100. The steering angle sensor 118 may include a digital sensor or an analog sensor. For example, the steering angle sensor 118 may include a magnetoresistance steering angle sensor. The steering angle sensor 118 may be coupled to a steering shaft (not shown) of the work machine 100. It should be noted that the work machine 100 may include any type of steering angle sensor 118 that generates the input signal “I2” corresponding to the steering angle of the work machine 100, without any limitations.

The work machine 100 further includes a pantograph 124 to engage with one or more overhead lines 120 for supplying electric power to the work machine 100. For example, the work machine 100 may receive the electric power through the pantograph 124 to drive one or more electric motors and move the work machine 100 on a grade. Further, the pantograph 124 is support by the frame 106. An operator may raise or lower the pantograph 124 relative to the overhead lines 120, as per application requirements. A process of engaging the pantograph 124 with the overhead lines 120 may be initiated by the operator based on activation of an operating switch 126 (shown in FIG. 2).

In the illustrated embodiment of FIG. 1, the pantograph 124 engages with a pair of the overhead lines 120. For explanatory purposes, only two overhead lines are illustrated herein. However, the pantograph 124 may engage with more than two overhead lines 120, as per application requirements. In order to receive the electric power from the overhead lines 120, the operator of the work machine 100 needs to ensure that the pantograph 124 of the work machine 100 is aligned with the overhead lines 120. A movement of the pantograph 124 may be controlled by the operator such that when the pantograph 124 is in contact with the overhead lines 120, the work machine 100 may receive a continuous supply of the electric power. It should be noted that the frame 106 is a ground connection. Further, one of the overhead lines 120 may provide positive direct current and the other one of the overhead lines 120 may provide negative direct current. The overhead lines 120 may form a part of an electric power transmission and distribution system that transmits electrical power across large distances. The overhead lines 120 may include one or more uninsulated electrical cables. The overhead lines 120 may be supported and mounted at worksites by a number of infrastructures 128, such as, poles, cantilever structures, and the like.

Further, the work machine 100 includes a first imaging device 130 (shown in FIG. 2). The first imaging device 130 may include a camera that may generate input signals “I3” (shown in FIG. 3). The input signals “I3” may include images of a surrounding of the work machine 100. It should be noted that the term “images” that are captured by the first imaging device 130 may include still images or videos. In some examples, the images may preferably include videos. In some examples, the first imaging device 130 may capture images of the front end 102 of the work machine 100, the rear end 104 of the work machine 100, the pantograph 124, the overhead lines 120, and the like. Further, the images captured by the first imaging device 130 may be displayed on the user interface present in the operator cabin 110. It should be noted that the first imaging device 130 may include any type of imaging device known in the art. Further, the work machine 100 may include the single first imaging device 130 or the work machine 100 may include multiple first imaging devices disposed at different locations on the work machine 100.

As shown in FIG. 2, the work machine 100 includes an operator assistance system 132 associated with the work machine 100. Specifically, the work machine 100 includes the operator assistance system 132 for providing a visual indication to the operator regarding an alignment of the work machine 100 relative to the overhead lines 120. Specifically, the operator assistance system 132 provides the visual indication of the pantograph 124 and the overhead lines 120 to the operator.

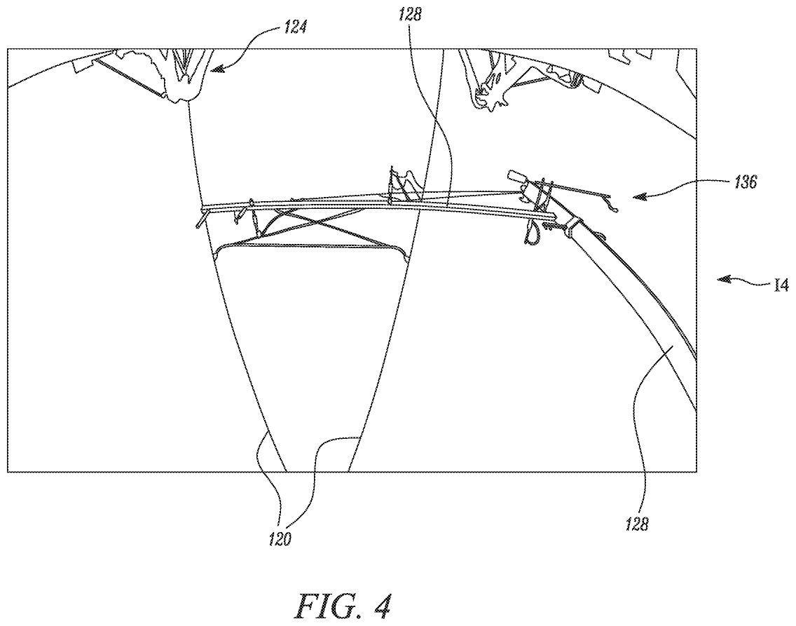

The operator assistance system 132 includes an imaging device 134 mounted on the work machine 100 and facing the overhead line 120 and the pantograph 124. The imaging device 134 captures an input image “I4” (shown in FIGS. 3 and 4) including a first pictorial view 136 (shown in FIG. 4) that includes the overhead line 120. It should be noted that the term “images” that are captured by the imaging device 134 may include still images or videos, that present a real time view of the pantograph 124 and the overhead lines 120. In some examples, the images may preferably include videos. For example, the input image “I4” in a video format may assist the operator to steer the work machine 100 until the pantograph 124 is in appropriate contact with the overhead lines 120. The imaging device 134 may be hereinafter interchangeably referred to as a second imaging device 134.

The second imaging device 134 may be disposed at a location on the work machine 100 such that each of the overhead lines 120 and the pantograph 124 lie in a field of view of the second imaging device 134. In an example, the second imaging device 134 may be disposed above the radiator 122 (see FIG. 1) of the work machine 100. In some examples, the second imaging device 134 may be movable relative to the frame 106 (see FIG. 1) of the work machine 100 to ensure that each of the overhead lines 120 and the pantograph 124 lie in the field of view of the second imaging device 134. Further, the location of the second imaging device 134 may be selected such that the second imaging device 134 may be accessible by the operator or the servicing personnel for servicing purposes. In the illustrated embodiment of FIG. 2, the operator assistance system 132 includes a single second imaging device 132. However, it is contemplated that the operator assistance system 132 may include multiple second imaging devices, without any limitations.

The second imaging device 134 may include a camera. In an example, the second imaging device 134 may include a digital video camera, such as, an ethernet camera to provide an electronic motion picture acquisition. It should be noted that the second imaging device 134 may include any other type of imaging device known in the art.

In an example, the second imaging device 134 may be activated when the work machine 100 is started. In another example, the second imaging device 134 may be activated by the operator. For example, the second imaging device 134 may be activated by the operator while engaging or disengaging the pantograph 124. In yet another example, the second imaging device 134 may be automatically activated when the pantograph 124 is being engaged with the overhead lines 120 or when the pantograph 124 is being raised. Further, in some examples, the second imaging device 134 may be deactivated based on an input from the operator. Alternatively, the second imaging device 134 may be automatically deactivated when the pantograph 124 is being disengaged from the overhead lines 120 or when the pantograph 124 is being lowered.

Referring to FIG. 3, the operator assistance system 132 includes a controller 138 communicably coupled with the imaging device 134. The controller 138 includes a memory 140. The memory 140 may include a flash memory, a random-access memory (RAM), an electrically erasable programmable read-only memory (EEPROM), and the like. The memory 140 may be used to store data such as algorithms, instructions, arithmetic operations, and the like. The controller 138 may execute various types of digitally-stored instructions, such as a software or an algorithm, retrieved from the memory 140, or a firmware program which may enable the controller 138 to perform a wide variety of operations. Further, the memory 140 may store a predetermined threshold speed value corresponding to the speed of the work machine 100 and a predetermined threshold steering angle value corresponding to the steering angle of the work machine 100.

The controller 138 also includes a processor 142. The processor 142 may be communicably coupled to the first imaging device 130 (see FIG. 2), the second imaging device 134 (see FIG. 2), the operating switch 126 (see FIG. 2), the speed sensor 116 (see FIG. 2), and the steering angle sensor 118 (see FIG. 2). Accordingly, the processor 142 may receive the input signals “I1”, “I2”, “I3” and the input images “I4”. Further, the processor 142 may be communicably coupled with the memory 140 via a bus or other connection.

The processor 142 may embody a single microprocessor or multiple microprocessors for receiving various input signals from various components of the work machine 100. Numerous commercially available microprocessors may be configured to perform the functions of the processor 142. It should be appreciated that the processor 142 may embody a machine microprocessor capable of controlling numerous machine functions. The processor 142 may include a central processing unit, a graphics processing unit, an accelerated processing unit, and the like. The processor 142 may also include a processing logic such as a field-programmable gate array (FPGA), an application-specific integrated circuit (ASIC), and the like.

A person of ordinary skill in the art will appreciate that the controller 138 may additionally include other components apart from the processor 142 and the memory 140, and may perform other functions not described herein. In some examples, diagnostic information related to the controller 138 and the second imaging device 134 may be displayed on the user interface present within the operator cabin 110.

Further, the exemplary input image “I4” that may be received by the processor 142 is illustrated in FIG. 4. As illustrated in FIG. 4, the input image “I4” includes the first pictorial view 136. The first pictorial view 136 illustrates a portion of the pantograph 124 in contact with the overhead lines 120.

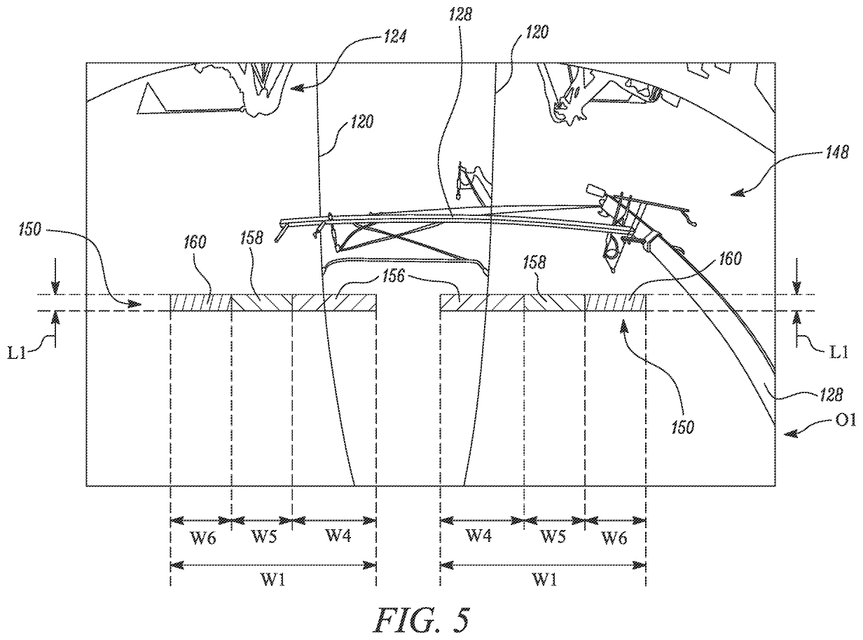

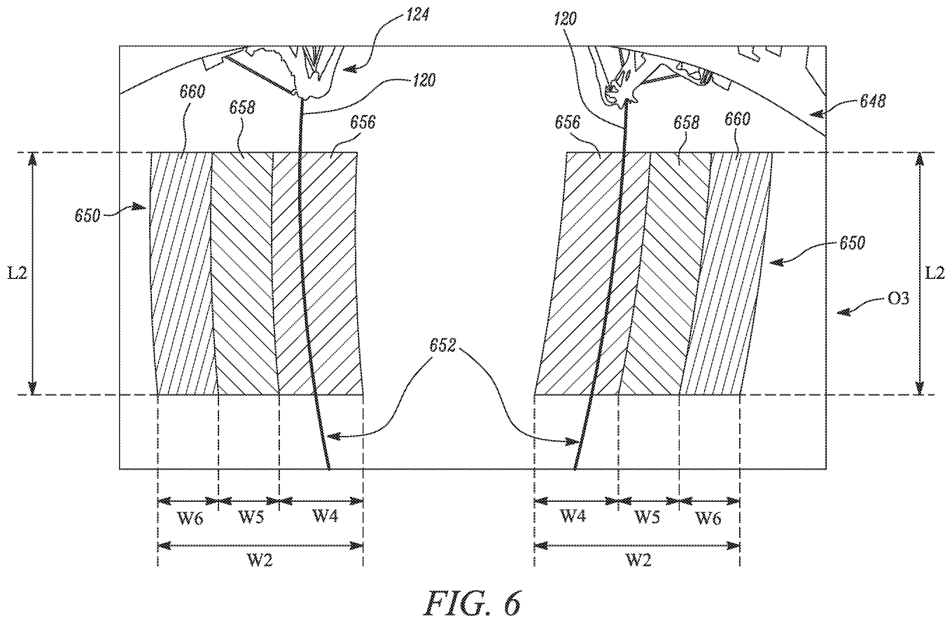

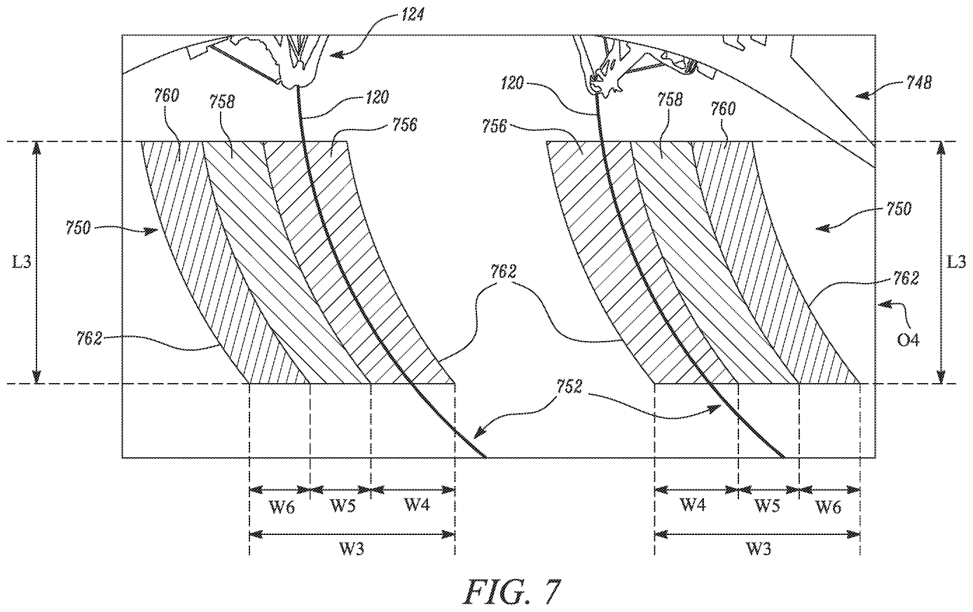

Referring again to FIG. 3, the controller 138 generates an output image “O1” including a second pictorial view 148 (shown in FIG. 5) and one or more first indication elements 150 (shown in FIG. 5) overlayed on the second pictorial view 148. The second pictorial view 148 is in part derived from the first pictorial view 136 (see FIG. 4) and includes the overhead lines 120 (see FIG. 5). Specifically, the processor 142 of the controller 138 may receive, analyze, and process the input image “I4”. In some examples, the processor 142 may analyze the input image “I4” to determine a relative positioning between the overhead lines 120 and the pantograph 124 (see FIG. 4) in the first pictorial view 136. In some examples, the processor 142 may retrieve a program or a software from the memory 140 to determine a positioning of the first indication elements 150 relative to the overhead lines 120. In other examples, the processor 142 may also determine a positioning of a second indication element 652, 752 (shown in FIGS. 6 and 7) on a second pictorial view 648, 748 (shown in FIGS. 6 and 7) based on determination of the overhead lines 120 in the first pictorial view 136 and overlaid atop a portion of the image of those overhead lines 120. The second indication elements 652, 752 will be explained later in this section

In some examples, the controller 138, and more particularly, the processor 142 may also determine a routing of the overhead lines 120. For example, the processor 142 may determine if the overhead lines 120 are curved to determine the routing of the overhead lines 120 along a curved path. Further, the processor 142 may modify the first pictorial view 136 based on one or more software or programs retrieved from the memory 140 of the controller 138. The modification of the first pictorial view 136 may include provision of the first indication elements 150. In some examples, an output image “O3”, “O4” may also include the second indication element 652, 752. The processor 142 may also generate an audible output signal “O2”. When the operator is raising the pantograph 124 for contacting with the overhead lines 120, the audible output signal “O2” may notify the operator if the pantograph 124 is in alignment with the work machine 100 based on the relative positioning between the overhead lines 120 and the pantograph 124 in the first pictorial view 136. Further, in some examples, when the work machine 100 is in motion, the audible output signal “O2” may notify the operator if the pantograph 124 is in appropriate contact with the overhead lines 120.

The operator assistance system 132 further includes a display device 154 (shown in FIG. 2) mounted on the work machine 100. Specifically, the operator assistance system 132 includes the display device 154 mounted within the operator cabin 110 (see FIG. 1) to receive the output image “O1” from the controller 138. The display device 154 may be embodied as a secondary display of the work machine 100.

The display device 154 is communicably coupled to the controller 138. The display device 154 displays the output image “O1” thereon for providing the visual indication to the operator signifying the alignment of the work machine 100 relative to the overhead lines 120. More particularly, the display device 154 displays the output image “O1” for providing the visual indication to the operator signifying the alignment of the pantograph 124 relative to the overhead lines 120.

In an example, the controller 138 may be an integral component of the display device 154. In another example, the controller 138 and the display device 154 may be embodied as separate components. The display device 154 may include an electroluminescent (ELD) display, liquid crystal display (LCD), light-emitting diode (LED) display, a thin-film transistor (TFT), and the like. Further, the display device 154 may include a portable handheld device, such as, a mobile phone, a tablet, and the like. The display device 154 may embody a touch screen. In such an example, the display device 154 may present various control icons on the touch screen for operator assistance. Alternatively, the display device 154 may include one or more physical input devices, such as, a switch, a button, a lever, a knob, and the like, without any limitations, as well as their image representations on the touch screen. It may also be contemplated that the display device 154 may embody a heads-up display unit, without any limitations.

In addition to the output image “O1”, the display device 154 may also receive and display the input signals “I3” (see FIG. 3), i.e., the images from the first imaging device 130 thereon. For example, when the output image “O1” is not being displayed on the display device 154, the display device 154 may display the images from the first imaging device 130. Moreover, the display device 154 may display the output image “O1” based on an operator input or an operating mode of the pantograph 124. In an example, the display device 154 may switch between displaying the images from the first imaging device 130 and the output image “O1” based on the operator input or the operating mode of the pantograph 124. For example, the output image “O1” may be displayed when the operator provides the operator input before initiating the process of engaging the pantograph 124 with the overhead lines 120. In some examples, the output image “O1” may be displayed when the operator provides the operator input before initiating a process of disengaging the pantograph 124 from the overhead lines 120. In an example, the operator input may be provided to the control icon displayed on the display device 154 or the input device of the display device 154.

Alternatively, the display device 154 may display the output image “O1”, based on the operating mode of the pantograph 124. In an example, the display device 154 may switch from displaying the images from the first imaging device 130 to displaying the output image “O1” based on the operating mode of the pantograph 124. For example, the output image “O1” may be displayed on the display device 154 when the pantograph 124 is being raised or engaged. In some examples, the output image “O1” may also be displayed when the pantograph 124 is being lowered or disengaged.

In other examples, the display device 154 may display the output image “O1” based on a position of the operating switch 126 (see FIG. 2) of the pantograph 124. For example, if the operating switch 126 is in an engaged position, the output image “O1” may be automatically displayed on the display device 154. In some examples, the output image “O1” may be displayed on the display device 154 until the operating switch 126 is in the engaged position. Further, the control icons and/or the input devices on the display device 154 may allow the operator to customize a length “L1” (shown in FIG. 5) or a width “W1” (shown in FIG. 5) of the first indication elements 150 or a thickness (for e.g., boldness) of the second indication element 652, 752. The control icons and/or the input devices may also allow the operator to zoom in or zoom out to examine the output image “O1”.

In some examples, the display device 154 may also include a speaker (not shown). The speaker may be communicably coupled with the processor 142 for receiving the audible output signals “O2”. The speaker may in turn provide audible alerts to the operator regarding the alignment of the pantograph 124 with the overhead lines 120. Further, the audible alerts may include a voice message or a horn, as per application requirements. For example, if the pantograph 124 is in alignment with the overhead lines 120, the audible alert may convey voice messages to the operator to alert the operator that the pantograph 124 is in alignment with the overhead lines 120. Further, if the pantograph 124 is in a misaligned position relative to the overhead lines 120, the audible alert may provide voice messages or an alarm to warn the operator regarding the misalignment. In some examples, the display device 154 may flash warning lights to alert the operator regarding the alignment or the misalignment of the pantograph 124 relative to the overhead lines 120. Thus, it may be noted that the display device 154 may use a single technique or a combination of techniques to alert the operator regarding the alignment or the misalignment of the pantograph 124 relative to the overhead lines 120.

FIG. 5 illustrates the exemplary output image “O1” including the second pictorial view 148. Specifically, the display device 154 (see FIG. 2) displays the second pictorial view 148 including the first indication elements 150 thereon. FIG. 5 illustrates the second pictorial view 148 when the work machine 100 is in a first condition. In the first condition, the work machine 100 may be at rest and the pantograph 124 may not be engaged with the overhead lines 120. Alternatively, in the first condition, the work machine 100 may be moving at a low speed and the pantograph 124 may be engaged with the overhead lines 120.

In the illustrated embodiment of FIG. 5, the second pictorial view 148 includes two first indication elements 150 corresponding to a total number of the overhead lines 120. Each first indication element 150 is substantially rectangular in shape. Further, a shape of each first indication element 150 may vary, without any limitations. Moreover, the one or more first indication elements 150 define the length “L1” and the width “W1”, such that the width “W1” of the one or more first indication elements 150 are substantially perpendicular to the overhead line 120 in the second pictorial view 148. Additionally, the length “L1” and the width “W1” of the first indication element 150 may vary, as per application requirements.

Moreover, the one or more first indication elements 150 define one or more reference zones 156, 158, 160, such that a presence of the overhead lines 120 of the second pictorial view 148 within the one or more reference zones 156, 158, 160 indicate that the work machine 100 is in desired alignment with the overhead lines 120. In some examples, the reference zones 156, 158, 160 may be defined based on the relative positioning between the overhead line 120 and the pantograph 124 (or a particular portion of the pantograph 124) in the first pictorial view 136.

The one or more reference zones 156, 158, 160 include a first reference zone 156 having a first unique feature, a second reference zone 158 having a second unique feature, and a third reference zone 160 having a third unique feature. A presence of the overhead lines 120 in the first reference zone 156 may be indicative of the alignment of the pantograph 124 with the overhead lines 120. Thus, if the overhead lines 120 lies in the first reference zone 156, it may be contemplated that the pantograph 124 may establish and maintain appropriate contact with the overhead lines 120 for receipt of the electric power. Further, a presence of the overhead lines 120 in the second reference zone 158 may be indicative of a possibility that the overhead lines 120 may be misaligned relative to the overhead lines 120. Thus, if the overhead lines 120 lie in the second reference zone 158, there may be a possibility that the pantograph 124 may not establish and maintain appropriate contact with the overhead lines 120 for receipt of the electric power. Moreover, a presence of the overhead lines 120 in the third reference zone 160 may indicate that the pantograph 124 is misaligned relative to the overhead lines 120. Thus, if the overhead lines 120 lie in the third reference zone 160, the pantograph 124 may not establish and maintain appropriate contact with the overhead lines 120 for receipt of the electric power. Such misalignment can occur if the operator of the work machine 100 does not properly position the work machine 100 beneath the overhead lines 120, causing the pantograph 124 to be shifted sideways relative to the overhead lines 120. By being able to see whether the depicted overhead lines 120 are in the reference zones 156, 158, or 160, the operator can quickly and easily determine whether the work machine 100 (and the associated pantograph 124) is properly positioned under those overhead lines 120 and, if the position of the work machine 100 is not optimal, can provide suitable steering inputs to change its position to bring the depicted overhead lines 120 into the desired reference zones 156.

Each of the first, the second, and the third reference zones 156, 158, 160 extend along the width “W1” of the one or more first indication elements 150. The first reference zone 156 defines a first width “W4”, the second reference zone 158 defines a second width “W5”, and the third reference zone 160 defines a third width “W6”. In some examples, the first width “W4”, the second width “W5”, and the third width “W6” may be different from each other. As illustrated, the first width “W4” is greater than the second and the third widths “W5”, “W6”. In other examples, the first width “W4”, the second width “W5” and the third width “W6” may be equal to each other.

In the illustrated embodiment of FIG. 5, the three reference zones 156, 158, 160 are illustrated by different hatchings to distinguish the three reference zones 156, 158, 160 from each other. Further, the first unique feature, the second unique feature, and the third unique feature may include unique color codes to distinguish the three reference zones 156, 158, 160 from each other. In some examples, the first reference zone 156 may be green in color, the second reference zone 158 may be yellow in color, and the third reference zone 160 may be red in color. Moreover, the display device 154 may display a legend (not shown) to indicate a meaning of each reference zone 156, 158, 160. Additionally, or alternatively, the reference zones 156, 158, 160 may include texts that allow the operator to distinguish the three reference zones 156, 158, 160 from each other. It should be noted that the reference zones 156, 158, 160 may include any other unique visible feature that may allow easy distinguishing between the different reference zones 156, 158, 160, without any limitations.

FIG. 6 illustrates the exemplary output image “O3” displayed on the display device 154 (see FIG. 2). The output image “O2” includes the second pictorial view 648 when the work machine 100 is in a second condition. In the second condition, the work machine 100 may be moving at a high speed and the pantograph 124 may be engaged with the overhead lines 120. More particularly, the controller 138 (see FIGS. 2 and 3) may receive the input signal “I1” (see FIG. 3) corresponding to the speed of the work machine 100 from the speed sensor 116 (see FIG. 2). Further, the controller 138 may compare the speed of the work machine 100 with the predetermined threshold speed value stored in the memory 140 (see FIG. 2). If the speed of the work machine 100 is greater than the predetermined threshold speed value, the controller 138 updates the output image “O3”. The controller 138 updates the output image “O3” such that a length “L2” of one or more first indication elements 650 varies according to the speed of the work machine 100. As illustrated, the length “L2” of the first indication elements 650 is greater than the length “L1” of the first indication elements 150 illustrated in FIG. 5. In some examples, such an increased length “L2” may give the operator more time to react and control the work machine 100 appropriately Further, a width “W2” of the first indication element 650 may be similar to the width “W1” of the first indication elements 150 illustrated in FIG. 5. Moreover, each first indication element 650 includes a first reference zone 656, a second reference zone 658, and a third reference zone 660 similar to the first, the second, and the third reference zones 156, 158, 160, respectively, of the first indication elements 150 illustrated in FIG. 5.

The output image “O3” also includes the second indication element 652 overlayed on the overhead lines 120 of the second pictorial view 648 to highlight the overhead lines 120 of the second pictorial view 648. The second indication element 652 may highlight the overhead lines 120 on the second pictorial view 648 to assist the operator in maintaining contact between the pantograph 124 and the overhead lines 120.

FIG. 7 illustrates the exemplary output image “O4” displayed by the display device 154 (see FIG. 2). The output image “O4” includes the second pictorial view 748 when the work machine 100 is in a third condition. In the third condition, the work machine 100 may be moving on a curved path at a high speed, and the pantograph 124 may be engaged with the overhead lines 120. Further, the controller 138 (see FIGS. 2 and 3) determines the routing of the overhead lines 120 along the curved path. In an example, for determining the routing of the overhead lines 120, the controller 138 may receive the input signal “I2” (see FIG. 3) corresponding to the steering angle of the work machine 100 from the steering angle sensor 118 (see FIG. 2). Further, the controller 138 may compare the steering angle of the work machine 100 with the predetermined threshold steering angle value stored in the memory 140 (see FIG. 3). If the controller 138 determines that the work machine 100 is moving on a curved path based on the comparison between the steering angle of the work machine 100 and the predetermined threshold steering angle, the controller 138 updates the output image “O4”. The controller 138 updates the output image “O4” such that one or more first indication elements 750 include a curved region 762 corresponding to the routing of the overhead lines 120 along the curved path. More specifically, each first indication element 750 includes a pair of the curved regions 762.

Further, the controller 138 also receives the input signal “I1” (see FIG. 3) corresponding to the speed of the work machine 100 from the speed sensor 116 (see FIG. 2). Moreover, the controller 138 may compare the speed of the work machine 100 with the predetermined threshold speed value. If the speed of the work machine 100 is greater than the predetermined threshold speed value, the controller 138 updates the output image “O4” to increase a length “L3” of the first indication elements 750. In some examples, such an increased length “L3” may give the operator more time to react and control the work machine 100 appropriately. As illustrated, the length “L3” is greater than the length “L1” of the first indication elements 150 illustrated in FIG. 5. Further, a width “W3” of the first indication element 750 may be similar to the width “W1” of the first indication elements 150 illustrated in FIG. 5. Moreover, the first indication elements 750 includes a first reference zone 756, a second reference zone 758, and a third reference zone 760 similar to the first, the second, and the third reference zones 156, 158, 160, respectively, of the first indication elements 150 illustrated in FIG. 5. Additionally, the second pictorial view 748 also includes the second indication element 752 that is substantially similar to the second indication element 652 illustrated in FIG. 6.

### INDUSTRIAL APPLICABILITY

The present disclosure relates to the operator assistance system 132 associated with the work machine 100 and a method 800 of assisting the operator of the work machine 100. The operator assistance system 132 and the method 800 may allow a real-time monitoring of the alignment between the pantograph 124 and the overhead lines 120. Specifically, the operator assistance system 132 and the method 800 may allow the operator to determine the alignment between the overhead lines 120 and the pantograph 124 of the work machine 100 to so that the pantograph 124 may establish and maintain appropriate contact with the overhead lines 120. Therefore, the operator assistance system 132 and the method 800 may reduce a possibility of breakdown of the overhead lines 120, the pantograph 124, or the work machine 100. Further, a possibility of unintentional pulling down of the overhead lines 120 due to non-alignment between the pantograph 124 and the overhead lines 120 may also be eliminated. Additionally, the operator assistance system 132 and the method 800 may also allow the operator to maintain proper contact between the pantograph 124 and the overhead lines 120 when the work machine 100 is moving, which can improve safety and productivity.

The operator assistance system 132 includes the imaging device 134 that assists the operator in aligning the pantograph 124 and/or maintaining contact of the pantograph 124 with the overhead lines 120. The imaging device 134 captures the input image “I4” including the first pictorial view 136 of the pantograph 124 and the overhead lines 120. The input image “I4” may provide a live feed in a still image format or a video format. It should be noted that the input image “I4” in the video format may help the operator to steer the work machine 100 for maintaining appropriate contact between the pantograph 124 and the overhead lines 120. The imaging device 134 may be mounted on the work machine 100 such that the imaging device 134 may be easily reachable by the operator or the servicing personnel for servicing or replacement purposes.

Further, the controller 138 of the operator assistance system 132 generates the output image “O1”, “O3”, “O4” including the first indication element 150, 650, 750. The first indication element 150, 650, 750 defines the reference zones 156, 158, 160, 656, 658, 660, 756, 758, 760 such that a presence or absence of the overhead lines 120 within the reference zones 156, 158, 160, 656, 658, 660, 756, 758, 760 may inform the operator regarding the alignment and/or the misalignment of the pantograph 124 with the overhead lines 120. Further, the reference zones 156, 158, 160, 656, 658, 660, 756, 758, 760 may also assist the operator in maintaining contact between the pantograph 124 and the overhead lines 120, as the operator can adjust the steering of the work machine 100 to maintain the images of the overhead lines 120 in the desired reference zones 156, 656, 756. In some examples, the output image “O3”, “O4” may also include the second indication element 652, 752. The second indication element 652, 752 highlights the overhead lines 120 on the second pictorial view 648, 748 so that the overhead lines 120 can be easily identified by the operator.

Further, the shape and the size of the first indication element 150, 650, 750 may vary based on the speed of the work machine 100 and the routing of the overhead lines 120 on curved paths. For example, when the work machine 100 is at rest or moving at low speeds, the first indication element 150 may define the shorter length “L1”. Further, when the work machine 100 is moving at higher speeds, the first indication element 650, 750 may define the longer length “L2”, “L3”. Furthermore, the first indication element 750 may include the curved regions 762 when the overhead lines 120 follow the curved path. Further, the operator assistance system 132 including the imaging device 134, the controller 138, and the display device 154 may form a kit that can be easily retrofitted on existing work machines during a servicing schedule with minimum modifications.

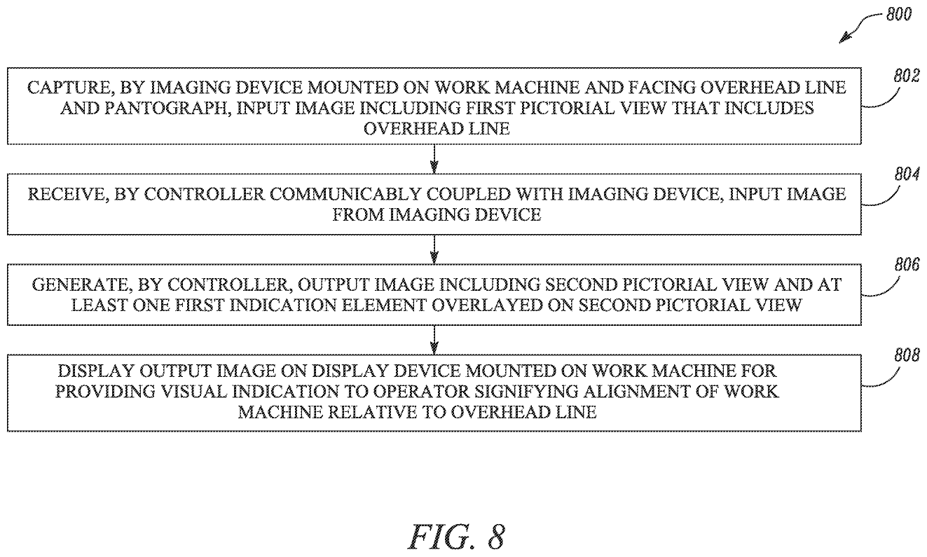

FIG. 8 illustrates a flowchart for the method 800 of assisting the operator of the work machine 100. The work machine 100 includes the pantograph 124 to engage with the one or more overhead lines 120 for supplying the electric power to the work machine 100. At step 802, the imaging device 134 mounted on the work machine 100 and facing the overhead lines 120 and the pantograph 124 captures the input image “I4” including the first pictorial view 136 that includes the overhead lines 120. At step 804, the controller 138 communicably coupled with the imaging device 134 receives the input image “I4” from the imaging device 134.

At step 806, the controller 138 generates the output image “O1”, “O3, “O4” including the second pictorial view 148, 648, 748 and the one or more first indication elements 150, 650, 750 overlayed on the second pictorial view 148. The second pictorial view 148 is in part derived from the first pictorial view 136 and includes the overhead lines 120. The one or more first indication elements 150, 650, 750 define the one or more reference zones 156, 158, 160, 656, 658, 660, 756, 758, 760, such that the presence of the overhead lines 120 of the second pictorial view 148, 648, 748 within the one or more reference zones 156, 158, 160, 656, 658, 660, 756, 758, 760 indicates that the work machine 100 is in desired alignment with the overhead lines 120. The one or more reference zones 156, 158, 160, 656, 658, 660, 756, 758, 760 include the first reference zone 156, 656, 756 having the first unique feature, the second reference zone 158, 658, 758 having the second unique feature, and the third reference zone 160, 660, 760 having the third unique feature. Each of the first, the second, and the third reference zones 156, 158, 160, 656, 658, 660, 756, 758, 760 extend along the width “W1”, “W2”, “W3” of the one or more first indication elements 150, 650, 750. Moreover, the step 806 of generating the output image “O3”, “O4” may further include overlaying the second indication element 652, 752 on the overhead lines 120 of the second pictorial view 648, 748 to highlight the overhead lines 120 of the second pictorial view 648, 748.

At step 808, the output image “O1”, “O3, “O4” is displayed on the display device 154 mounted on the work machine 100 for providing the visual indication to the operator signifying the alignment of the work machine 100 relative to the overhead lines 120. The display device 154 receives the output image “O1”, “O3, “O4” from the controller 138. The output image “O1”, “O3, “O4” is further displayed on the display device 154 based on one or more of the operator input and the operating mode of the pantograph 124.

In an example, the controller 138 further receives the signal “I1” corresponding to the speed of the work machine 100. The controller 138 updates the output image “O3”, “O4” such that the length “L2”, “L3” of the one or more first indication elements 650, 750 vary according to the speed of the work machine 100. For example, the length “L2”, “L3” increases as the speed of the work machine 100 increases.

In another example, the controller 138 further determines the routing of the overhead lines 120 along the curved path. The controller 138 updates the output image “O4” such that the one or more first indication elements 750 include the curved region 762 corresponding to the routing of the overhead lines 120 along the curved path.

It may be desirable to perform one or more of the step shown in FIG. 8 in an order different from that depicted. Furthermore, various steps could be performed together.

While aspects of the present disclosure have been particularly shown and described with reference to the embodiments above, it will be understood by those skilled in the art that various additional embodiments may be contemplated by the modification of the disclosed machines, systems, and methods without departing from the spirit and scope of what is disclosed. Such embodiments should be understood to fall within the scope of the present disclosure as determined based upon the claims and any equivalents thereof.

1. An operator assistance system associated with a work machine, the work machine including a pantograph adapted to engage with at least one overhead line for supplying electric power to the work machine, the operator assistance system comprising:
an imaging device mounted on the work machine and facing the overhead line and the pantograph, the imaging device being configured to capture an input image including a first pictorial view that includes the overhead line;
a controller communicably coupled with the imaging device, wherein the controller is configured to:
receive the input image from the imaging device; and
generate an output image including a second pictorial view and at least one first indication element overlayed on the second pictorial view, wherein the second pictorial view is at least in part derived from the first pictorial view and includes the overhead line, and wherein the at least one first indication element defines at least one reference zone, such that a presence of the overhead line of the second pictorial view within the at least one reference zone indicates that the work machine is in desired alignment with the overhead line; and
a display device mounted on the work machine and configured to receive the output image from the controller, wherein the display device is configured to display the output image thereon for providing a visual indication to an operator signifying an alignment of the work machine relative to the overhead line.

2. The operator assistance system of claim 1, wherein the at least one first indication element defines a length and a width, such that the width of the at least one first indication element is substantially perpendicular to the overhead line in the second pictorial view.

3. The operator assistance system of claim 2, wherein the at least one reference zone includes a first reference zone having a first unique feature, a second reference zone having a second unique feature, and a third reference zone having a third unique feature, and wherein each of the first, the second, and the third reference zones extend along the width of the at least one first indication element.

4. The operator assistance system of claim 2, wherein the controller is configured to receive a signal corresponding to a speed of the work machine, and wherein the controller is configured to update the output image such that the length of the at least one first indication element varies according to the speed of the work machine.

5. The operator assistance system of claim 1, wherein the controller is configured to determine a routing of the overhead line along a curved path, and wherein the controller is configured to update the output image such that the at least one first indication element includes a curved region corresponding to the routing of the overhead line along the curved path.

6. The operator assistance system of claim 1, wherein the output image includes a second indication element overlayed on the overhead line of the second pictorial view to highlight the overhead line of the second pictorial view.

7. The operator assistance system of claim 1, wherein the display device is configured to display the output image based on at least one of an operator input and an operating mode of the pantograph.

8. A work machine comprising:
a frame;
an operator cabin supported by the frame;
a pantograph adapted to engage with at least one overhead line for supplying electric power to the work machine; and
an operator assistance system for providing a visual indication to an operator regarding an alignment of the work machine relative to the overhead line, the operator assistance system comprising:
an imaging device mounted on the work machine and facing the overhead line and the pantograph, the imaging device being configured to capture an input image including a first pictorial view that includes the overhead line;
a controller communicably coupled with the imaging device, wherein the controller is configured to:
receive the input image from the imaging device; and
generate an output image including a second pictorial view and at least one first indication element overlayed on the second pictorial view, wherein the second pictorial view is at least in part derived from the first pictorial view and includes the overhead line, and wherein the at least one first indication element defines at least one reference zone, such that a presence of the overhead line of the second pictorial view within the at least one reference zone indicates that the work machine is in desired alignment with the overhead line; and
a display device mounted within the operator cabin and configured to receive the output image from the controller, wherein the display device is configured to display the output image thereon for providing the visual indication to the operator signifying the alignment of the work machine relative to the overhead line.

9. The work machine of claim 8, wherein the at least one first indication element defines a length and a width, such that the width of the at least one first indication element is substantially perpendicular to the overhead line in the second pictorial view.

10. The work machine of claim 9, wherein the at least one reference zone includes a first reference zone having a first unique feature, a second reference zone having a second unique feature, and a third reference zone having a third unique feature, and wherein each of the first, the second, and the third reference zones extend along the width of the at least one first indication element.

11. The work machine of claim 9, wherein the controller is configured to receive a signal corresponding to a speed of the work machine, and wherein the controller is configured to update the output image such that the length of the at least one first indication element varies according to the speed of the work machine.

12. The work machine of claim 8, wherein the controller is configured to determine a routing of the overhead line along a curved path, and wherein the controller is configured to update the output image such that the at least one first indication element includes a curved region corresponding to the routing of the overhead line along the curved path.

13. The work machine of claim 8, wherein the output image includes a second indication element overlayed on the overhead line of the second pictorial view to highlight the overhead line of the second pictorial view.

14. The work machine of claim 8, wherein the display device is configured to display the output image based on at least one of an operator input and an operating mode of the pantograph.

15. A method of assisting an operator of a work machine, the work machine including a pantograph adapted to engage with at least one overhead line for supplying electric power to the work machine, the method comprising:
capturing, by an imaging device mounted on the work machine and facing the overhead line and the pantograph, an input image including a first pictorial view that includes the overhead line;
receiving, by a controller communicably coupled with the imaging device, the input image from the imaging device;
generating, by the controller, an output image including a second pictorial view and at least one first indication element overlayed on the second pictorial view, wherein the second pictorial view is at least in part derived from the first pictorial view and includes the overhead line, and wherein the at least one first indication element defines at least one reference zone, such that a presence of the overhead line of the second pictorial view within the at least one reference zone indicates that the work machine is in desired alignment with the overhead line; and
displaying the output image on a display device mounted on the work machine for providing a visual indication to the operator signifying an alignment of the work machine relative to the overhead line, wherein the display device is configured to receive the output image from the controller.

16. The method of claim 15, wherein the at least one reference zone includes a first reference zone having a first unique feature, a second reference zone having a second unique feature, and a third reference zone having a third unique feature, and wherein each of the first, the second, and the third reference zones extend along a width of the at least one first indication element.

17. The method of claim 16 further comprising receiving, by the controller, a signal corresponding to a speed of the work machine, wherein the controller is configured to update the output image such that a length of the at least one first indication element varies according to the speed of the work machine.

18. The method of claim 15 further comprising determining, by the controller, a routing of the overhead line along a curved path, wherein the controller is configured to update the output image such that the at least one first indication element includes a curved region corresponding to the routing of the overhead line along the curved path.

19. The method of claim 15, wherein the step of generating the output image further comprises overlaying a second indication element on the overhead line of the second pictorial view to highlight the overhead line of the second pictorial view.

20. The method of claim 15 further comprising displaying the output image on the display device based on at least one of an operator input and an operating mode of the pantograph.
